(19) United States
(12) Patent Application Publication
(10) Pub. No.: US 2008/0288501 A1
(43) Pub. Date: Nov. 20, 2008

(54) Integrating Database Functionality with Workload Schedulers

(76) Inventor: Michael Bender, Rye Brook, NY (US)

Correspondence Address: DILLON & YUDELL LLP, 8911 N. CAPITAL OF TEXAS HWY.,, SUITE 2110, AUSTIN, TX, 78759, US

(21) Appl. No.: 11/748,299

(22) Filed: May 14, 2007

(51) Int. Cl. G06F 17/30

(52) U.S. Cl. 707/10; 707/E17.032

(57) ABSTRACT

A relational database trigger that accesses a distributed database table is initially created. This relational database trigger is defined prior to executing a first set of instructions, which are designed to be executed by a local first computer. The first set of instructions is executed until the relational database trigger is encountered, which causes a distributed database table to be accessed. Using information from the distributed database table, a dummy file is transmitted to a remote second computer. In response to the remote second computer receiving the dummy file, a scheduler searches the specific file location on the remote second computer for the dummy file. If the scheduler detects the dummy file at the specific file location, the remote second computer initiates execution of the second set of instructions.

### BACKGROUND OF THE INVENTION

The present invention relates in general to data processing systems and in particular to software. Still more particularly, the present invention relates to utilizing a novel type of database trigger to facilitate software scheduling.

In a distributed computer system, multiple computers can work on different parts of a job. That is, a job can be made up of a first set of instructions and a different second set of instructions. Thus, a first computer can execute the first set of instructions, and thereafter a second computer can execute the second set of instructions. Coordination of such execution is performed through file sharing and scheduling:

### SUMMARY OF AN EMBODIMENT

Disclosed are a method, system, and computer storage medium for executing a software job that comprises a first set of instructions and a second set of instructions. A relational database trigger that accesses a distributed database table is initially created. This relational database trigger is inserting into the first set of instructions, which are designed to be executed by a local first computer. The first set of instructions is executed until the relational database trigger is encountered. Encountering the relational database trigger causes a distributed database table to be accessed. The distributed database table includes table information that comprises a trigger name for the relational database trigger, a name of a dummy file that contains no data, a name of a server to which the dummy file is to be sent, an identifier required to access a remote second computer, a password needed to access the remote second computer, and a specific file location on the remote second computer to which the dummy file will be stored by the remote second computer. Using this table information, the dummy file is transmitted to the remote second computer. In response to the remote second computer receiving the dummy file, a scheduler is directed to search the specific file location on the remote second computer for the dummy file. If the scheduler detects the dummy file at the specific file location, execution of the second set of instructions is initiated on the remote second computer.

The above as well as additional objectives, features, and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 depicts a high level block diagram of an exemplary computer, according to an embodiment of the present invention;

FIG. 2 illustrates a DB2 trigger calling a DB2 table, which sends a dummy file from a first computer to a second computer;

FIG. 3 is a flow-chart of exemplary steps taken to create and utilize a DB2 trigger to send the dummy file described in FIG. 2; and

FIG. 4 is a flow-chart of exemplary steps taken to receive and utilize the dummy file described in FIG. 3.

### DETAILED DESCRIPTION OF AN ILLUSTRATIVE EMBODIMENT

When trying to schedule batch jobs, different tools use different methodologies for scheduling jobs. These include, but are not limited to, time of day, completion of previous task, availability of a file and others. In some scenarios, a software job may include a first set of instructions and a second set of instructions, which may not be executed concurrently on different computers. That is, only when the first set of instructions is completed (or alternatively “on hold”) can the second set of instructions be executed. Directing the second computer to start executing the second set of instructions could be handled by a File Transfer Protocol (FTP) message. However, the use of such FTP messages requires the same code to be written frequently; compromises security since the password is now stored in the source code; requires code changes to the application as the code is promoted through the development landscape into test and production; and requires code changes when the target server or database is changed. These all lead to additional development costs and time. Thus, presently disclosed is a novel use of a new type of DB2 trigger to prompt the sending of a dummy file to a second computer, which will authorize the scheduling of execution of the second set of instructions.

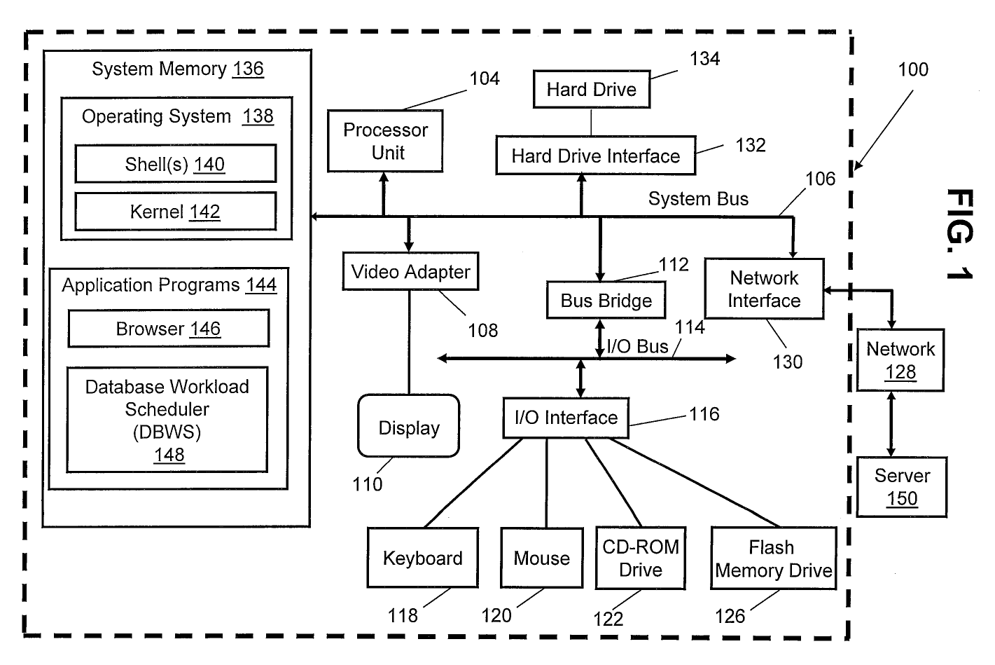

With reference now to FIG. 1, there is depicted a block diagram of an exemplary computer 100, with which the present invention may be utilized. Computer 100 includes a processor unit 104 that is coupled to a system bus 106. A video adapter 108, which drives/supports a display 110, is also coupled to system bus 106. System bus 106 is coupled via a bus bridge 112 to an Input/Output (I/O) bus 114. An I/O interface 116 is coupled to I/O bus 114. I/O interface 116 affords communication with various I/O devices, including a keyboard 118, a mouse 120, a Compact Disk-Read Only Memory (CD-ROM) drive 122, and a flash memory drive 126. The format of the ports connected to I/O interface 116 may be any known to those skilled in the art of computer architecture, including but not limited to Universal Serial Bus USB) ports.

Computer 100 is able to communicate with a server 150 via a network 128 using a network interface 130, which is coupled to system bus 106. Network 128 may be an external network such as the Internet, or an internal network such as an Ethernet or a Virtual Private Network (VPN). Server 150 may be architecturally configured in the manner depicted for computer 100.

A hard drive interface 132 is also coupled to system bus 106. Hard drive interface 132 interfaces with a hard drive 134. In one embodiment, hard drive 134 populates a system memory 136, which is also coupled to system bus 106. System memory 136 is defined as a lowest level of volatile memory in computer 100. This volatile memory may include additional higher levels of volatile memory (not shown), including, but not limited to, cache memory, registers, and buffers. Code that populates system memory 136 includes an operating system (OS) 138 and application programs 144.

OS 138 includes a shell 140, for providing transparent user access to resources such as application programs 144. Generally, shell 140 (as it is called in UNIX®) is a program that provides an interpreter and an interface between the user and the operating system. Shell 140 provides a system prompt, interprets commands entered by keyboard 118, mouse 120, or other user input media, and sends the interpreted command(s) to the appropriate lower levels of the operating system (e.g., kernel 142) for processing. As depicted, OS 138 also includes kernel 142, which includes lower levels of functionality for OS 138. Kernel 142 provides essential services required by other parts of OS 138 and application programs 144. The services provided by kernel 142 include memory management, process and task management, disk management, and I/O device management.

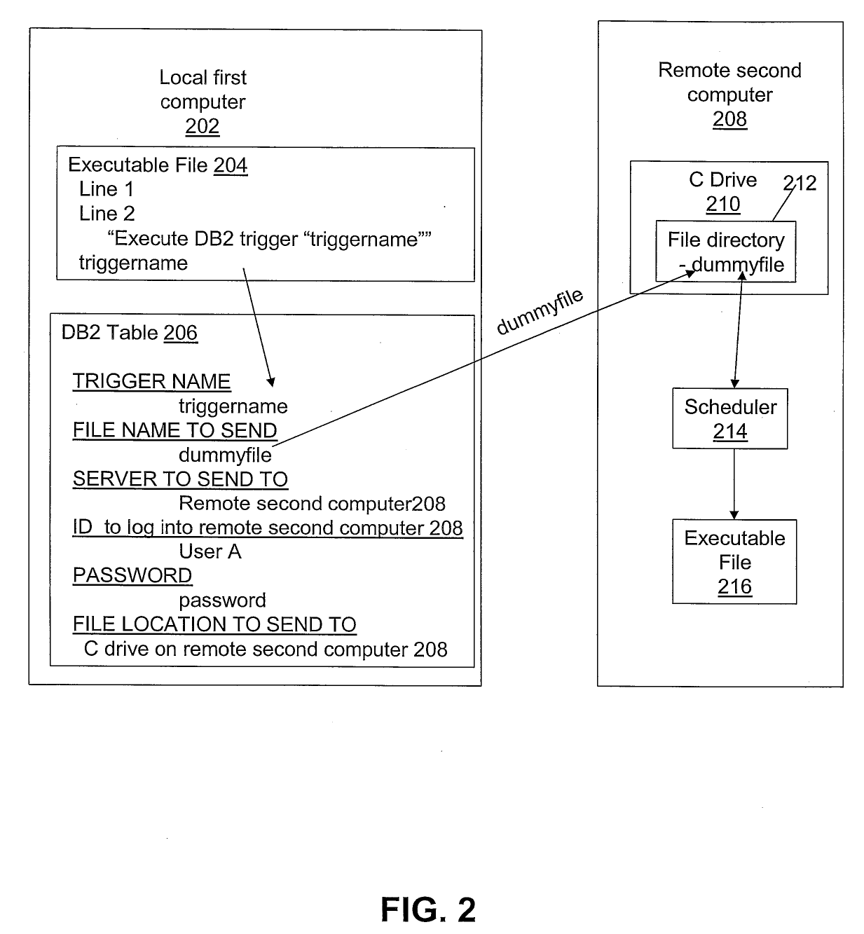

Application programs 144 include a browser 146. Browser 146 includes program modules and instructions enabling a World Wide Web (WWW) client (i.e., computer 100) to send and receive network messages to the Internet. Computer 100 may utilize HyperText Transfer Protocol (HTTP) messaging to enable communication with server 150. Application programs 144 in system memory 136 also include a Database Workload Scheduler (DBWS) 148. DBWS 148 performs the functions illustrated in FIGS. 2-4, which are discussed below.

The hardware elements depicted in computer 100 are not intended to be exhaustive, but rather represent and/or highlight certain components that may be utilized to practice the present invention. For instance, computer 100 may include alternate memory storage devices such as magnetic cassettes, Digital Versatile Disks (DVDs), Bernoulli cartridges, and the like. These and other variations are intended to be within the spirit and scope of the present invention. Note also that computer 100 may be a local first computer 202, and server 150 (or an equivalently architected client computer) may be a remote second computer 208, both shown in FIG. 2.

With reference now to FIG. 2, there is illustrated a high level overview of how a novel relational database trigger, such as a new type of DB2 trigger, is used to cause a remote computer to begin execution of instructions that are part of a software job. As depicted, a local first computer 202 is designated to execute a first executable file 204, which is part of a larger software job that includes executable file 204 and an executable file 216. A novel DB2 trigger has been previously created, using pseudocode such as:

<CREATE TRIGGER triggername
BEFORE/AFTER insert/update/delete
OF table underlying executable file 204
DUMMYFILE SentToUsing triggername>

Thus, the DB2 trigger named “triggername” is made resident in DB2. This trigger can be run before or after executable file 204 is executed. The execution of executable file 204 results in a section (e.g., a row) of an underlying table being altered (inserted or updated or deleted). Before/after this insertion/updating/deleting occurs, the DB2 trigger “triggername” fires, resulting in the file “dummyfile” being sent to the destination (remote second computer 206) described in the DB2 table 206 that is called by the DB2 trigger named “triggername.”

Thus, when the local first computer 202 encounters (during execution of the executable file 204) a DB2 trigger (“triggername”), a DB2 table 206 is accessed. As shown in exemplary manner, DB2 table 206 includes table information. This table information includes the name (“triggername”) of the DB2 trigger that causes the DB2 table 206 to be accessed. It also includes the name of an empty dummy file that is to be sent to a remote second computer 208, for purposes described later. Besides access information needed to touch the remote second computer 208 (i.e., the name of the remote second computer (“Remote second computer 208”), and the ID (“User A”) and password (“password”)), the table information also includes the actual file location to which the dummy file will be sent (“C drive on remote second computer 208”).

Using this table information, the empty file “dummyfile” is sent to the remote second computer 208 when the DB2 trigger “triggername” is encountered during the execution of the executable file 204. This empty file “dummyfile”, with a target name as defined in DB2 table 206, is then stored in the C drive 210 in a file directory 212 of the remote second computer 208. Thereafter, when a scheduler 214 (shown in exemplary manner as being resident within remote second computer 208, although alternatively scheduler 214 may reside anywhere it is accessible by remote second computer 208) detects that the file “dummyfile” has been stored at a specific location in the file directory 212, this “tells” the scheduler 214 that the remote second computer 208 may now begin executing executable file 216. Note that executable file 204 and executable file 216 may be two components of a single software job, but may not be executed at the same time for any of various reasons (data dependency, time constraints, resource allocation, etc.).

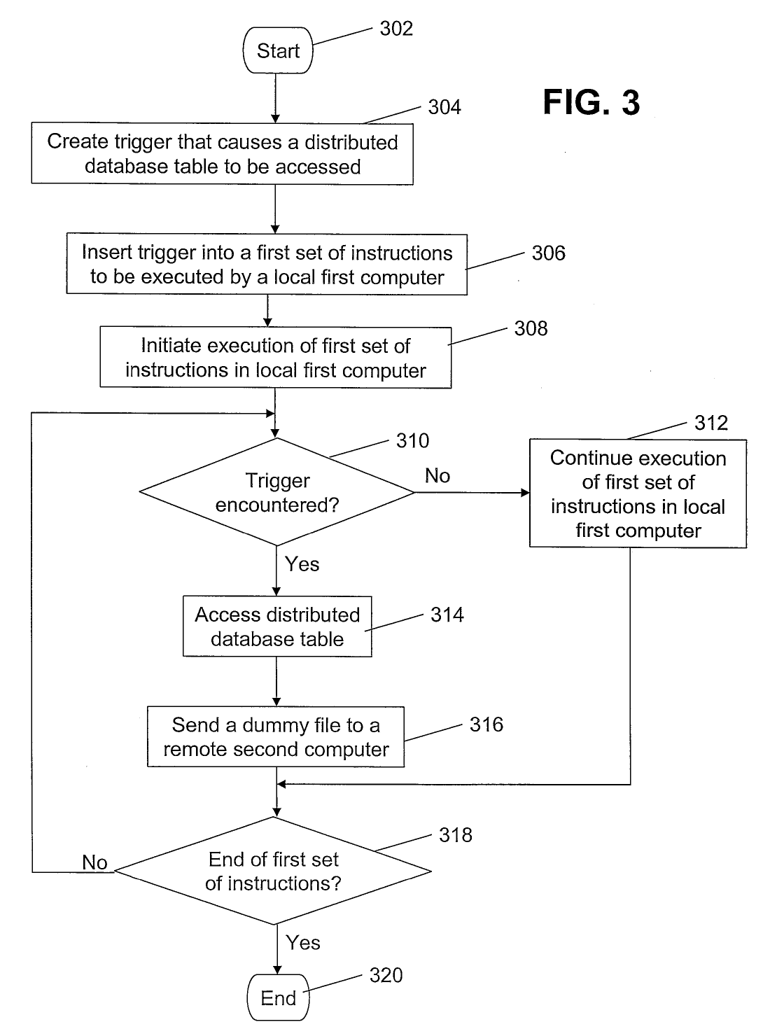

Referring now to FIG. 3, a high-level flow chart of exemplary steps taken to create and utilize a distributed database trigger (e.g., a DB2 trigger) is presented. After initiator block 302, which may be prompted by a decision to code a software job using the novel DB2 trigger described herein, a DB2 trigger is created (block 304). This DB2 trigger is able to cause a DB2 table (e.g., DB2 table 206 shown in FIG. 2) to be accessed. This DB2 trigger is then inserted into a first set of instructions, which make up part of a total software job (that also includes a second set of instructions). As described above, the first set of instructions is designated for execution by a local first computer, while the second set of instructions is designated for execution by a remote second computer.

As described in block 308, the first set of instructions execute until the DB2 trigger is encountered. Note that this trigger is shown at an end of the executable file 204 shown in FIG. 2, such that the DB2 trigger is fired after execution of the executable file 204 is finished. Alternatively, however, the DB2 trigger may be placed anywhere within the executable file 204. For example, if the DB2 trigger were placed at the beginning of the executable file 204, the DB2 trigger would be fired first, thus informing the remote second computer that the first local computer is about to start executing executable file 204.

Returning to FIG. 3, a query is made as to whether the DB2 trigger has been encountered (query block 310), and thus executed (“fired”). If not, then the execution of instructions in the first set of instructions continues normally (block 312). However, if the DB2 trigger has been encountered, then the DB2 table is accessed (block 314), resulting in an empty dummy file being sent to the remote second computer (block 316). Assuming that all instructions have been executed (block 318), the process ends (terminator block 320).

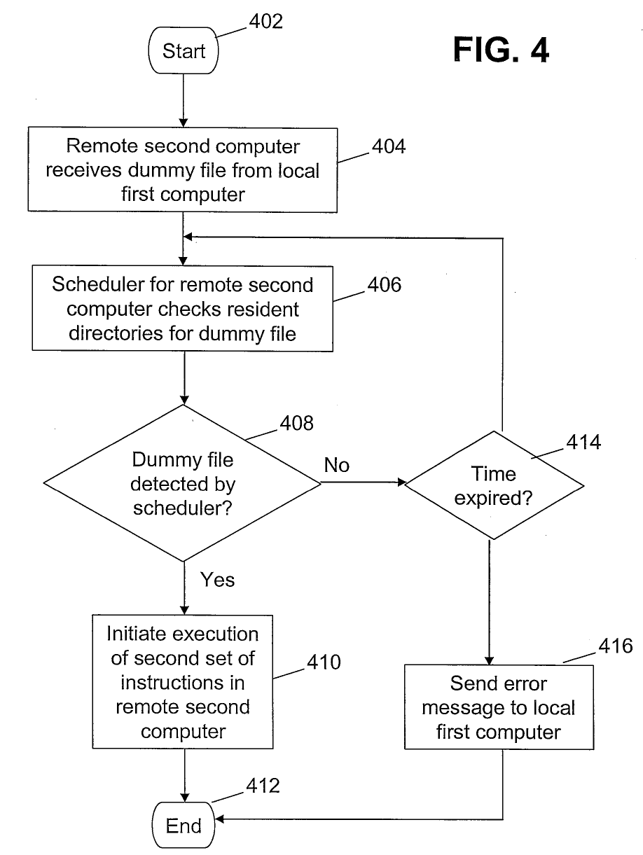

Referring now to FIG. 4, a flow-chart showing exemplary steps taken by the remote second computer are shown. After initiator block 402, which may be prompted by the local first computer executing the DB2 trigger described above, the remote second computer receives the dummy (empty) file from the local first computer (block 404), in accordance with the table information found in the DB2 table (e.g., DB2 table 206 shown in FIG. 2). A scheduler for the remote second computer checks resident directories, which are located on or accessible to the remote second computer (block 406). If the dummy file is found by the scheduler in the proper directory (query block 408), then the remote second computer is deemed authorized to begin execution of the second set of instructions (block 410), and the process ends (terminator block 412). However, if the dummy file is not in the proper directory, even though the dummy file was sent by the local first computer, then a check is made to see if a time limit has expired (query block 414). If so, then an error message is sent (i.e., to the local first computer or to the scheduler) stating that the dummy file was not stored in the proper location on the remote second computer (block 414). However, if the file is not found in the correct location on the second computer, the workload scheduler waits until the file arrives, thus returning from query block 414 back up to block 406. That is, the workload scheduler will only send an error message out if there is a time dependency. For example if “dummyfile” in C:\triggerexample is supposed to trigger the continuation of the work (see block 410), but “dummyfile” actually arrives in D:\triggerexample, the remote second computer just waits. This provides an additional benefit of the current invention, since locations can frequently change as a software job transitions from development to test and production.

While an illustrative embodiment of the present invention has been described in the context of a fully functional computer system with installed software, those skilled in the art will appreciate that the software aspects of an illustrative embodiment of the present invention are capable of being distributed as a program product in a variety of forms, and that an illustrative embodiment of the present invention applies equally regardless of the particular type of signal bearing media used to actually carry out the distribution. Examples of signal bearing media include recordable type media such as thumb drives, floppy disks, hard drives, CD ROMs, DVDs, and transmission type media such as digital and analog communication links.

While the invention has been particularly shown and described with reference to a preferred embodiment, it will be understood by those skilled in the art that various changes in form and detail may be made therein without departing from the spirit and scope of the invention.

What is claimed is:

1. In a distributed computer system, a method for executing a software job that comprises a first set of instructions and a second set of instructions, the method comprising:
creating a relational database trigger that accesses a distributed database table;
executing the relational database trigger from the first set of instructions, wherein the first set of instructions is designed to be executed by a local first computer;
in response to the local first computer executing the relational database trigger, accessing the distributed database table, wherein the distributed database table comprises table information that comprises a trigger name for the relational database trigger, a name of a dummy file that contains no data, a name of a server to which the dummy file is to be sent, an identifier required to access a remote second computer, a password needed to access the remote second computer, and a specific file location on the remote second computer to which the dummy file will be stored by the remote second computer;
using the table information to transmit the dummy file to the remote second computer;
in response to the remote second computer receiving the dummy file, directing a scheduler to search the specific file location on the remote second computer for the dummy file; and
in response to the scheduler detecting the dummy file at the specific file location, initiating execution of the second set of instructions on the remote second computer.

2. The method of claim 1, wherein the distributed database table is a DB2 table.

3. The method of claim 1, wherein the first set of instructions causes a row of an underlying table to be altered, and wherein the relational database trigger is executed only when the row is altered by the first set of instructions.

4. A computer system comprising:
a processor;
a data bus coupled to the processor;
a memory coupled to the data bus; and
a computer-usable medium embodying computer program code, the computer program code comprising instructions executable by the processor and configured for executing a software job that comprises a first set of instructions and a second set of instructions by performing the steps of:
creating a relational database trigger that accesses a distributed database table;
inserting the relational database trigger into the first set of instructions, wherein the first set of instructions are designed to be executed by a local first computer;
initiating execution of the first set of instructions in the local first computer;
in response to the local first computer executing the relational database trigger, accessing the distributed database table, wherein the distributed database table comprises table information that comprises a trigger name for the relational database trigger, a name of a dummy file that contains no data, a name of a server to which the dummy file is to be sent, an identifier required to access a remote second computer, a password needed to access the remote second computer, and a specific file location on the remote second computer to which the dummy file will be stored by the remote second computer;
using the table information to transmit the dummy file to the remote second computer;
in response to the remote second computer receiving the dummy file, directing a scheduler to search the specific file location on the remote second computer for the dummy file; and
in response to the scheduler detecting the dummy file at the specific file location, initiating execution of the second set of instructions on the remote second computer.

5. The computer system of claim 4, wherein the distributed database table is a DB2 table.

6. A computer storage medium encoded with a computer program that, when executed, performs the steps of:
creating a relational database trigger that accesses a distributed database table;
inserting the relational database trigger into the first set of instructions, wherein the first set of instructions are designed to be executed by a local first computer;
initiating execution of the first set of instructions in the local first computer;
in response to the local first computer executing the relational database trigger, accessing the distributed database table, wherein the distributed database table comprises table information that comprises a trigger name for the relational database trigger, a name of a dummy file that contains no data, a name of a server to which the dummy file is to be sent, an identifier required to access a remote second computer, a password needed to access the remote second computer, and a specific file location on the remote second computer to which the dummy file will be stored by the remote second computer;
using the table information to transmit the dummy file to the remote second computer;
in response to the remote second computer receiving the dummy file, directing a scheduler to search the specific file location on the remote second computer for the dummy file; and
in response to the scheduler detecting the dummy file at the specific file location, initiating execution of the second set of instructions on the remote second computer.
